(19) United States
(12) Patent Application Publication
(10) Pub. No.: US 2002/0118276 A1
(43) Pub. Date: Aug. 29, 2002

(54) Stereoscopic image system with polarization display unit

(76) Inventor: Phil Moon Seong, Yongin-city (KR)

Correspondence Address: KNOBLE & YOSHIDA, LLC, Eight Penn Center, Suite 1350, 1628 John F. Kennedy Blvd., Philadelphia, PA, 19103, US

(21) Appl. No.: 10/003,796

(22) Filed: Oct. 23, 2001

(30) Foreign Application Priority Data
Feb. 23, 2001 (KR) 2001-4764

(51) Int. Cl. H04N 13/04

(52) U.S. Cl. 348/53; 348/58

(57) ABSTRACT

Disclosed herein is a stereoscopic image system with a polarization display unit. A stereoscopic image system has a display unit for outputting left and right stereoscopic images for left and right eyes in sequence according to synchronizing signals of stereoscopic image signals. A polarizing filter is arranged on the display unit for polarizing the left and right stereoscopic image from the display unit to have a single directional propagation characteristic. A liquid crystal is arranged on the polarizing filter to output the left and right stereoscopic images to be perpendicular to each other. A pair of polarizing glasses is comprised of left and right polarizing filters having polarization directions perpendicular to each other.

### BACKGROUND OF THE INVENTION

1. Field of the Invention

The present invention relates generally to a stereoscopic image system using the polarization of a display unit, and more particularly to a stereoscopic image system, in which a liquid crystal shutter consisting of a liquid crystal and a polarizing filter is arranged on a display unit to output through the liquid crystal shutter images whose left and right images are perpendicular to each other, and the images outputted from the display unit are visualized through a pair of polarizing filter glasses worn by a user as stereoscopic images, thereby preventing flickering from occurring when the user views surrounding objects except for the stereoscopic image.

2. Description of the Prior Art

FIGS. 1a and 1b are views showing the light interception and light transmission when a liquid crystal is driven and not driven, respectively, in a conventional liquid crystal shutter.

As well known to those skilled in the art, a liquid crystal 12 shown in FIGS. 1a and 1b typically has a twisted-molecule array. When a driving voltage is not applied to the liquid crystal 12, the molecules of the liquid crystal 12 are twisted by an angle of approximately 90 degrees, and so light incident on the liquid crystal 12 is also twisted by 90 degrees. In contrast, when the driving voltage is applied to the liquid crystal 12, the molecules of the liquid crystal 12 are arranged in parallel with the direction of an electric field due to a dielectric effect, and so light incident on the liquid crystal 12 is transmitted in parallel with the direction of the electric field along the molecules of the liquid crystal 12.

As shown in FIGS. 1a and 1b, the left and right liquid crystal shutters 13 of conventional liquid crystal shutter glasses for viewing a stereoscopic image by selectively transmitting and intercepting light using the above-described characteristics of the liquid crystal 12 each comprise the liquid crystal 12 and front and rear polarizing filters 11a and 11b. The polarizing filters 11a and 11b are respectively arranged on the front and back surfaces of the liquid crystal 12, and have directions perpendicular to each other. The left and right liquid crystal shutters 13 are alternately closed and opened by alternately driving the left and right liquid crystals 12 according to the synchronizing signals of left and right images, thus allowing the user to view images for a left eye with only his or her left eye and to view images for a right eye with only his or her right eye.

FIG. 1a shows the propagation of light passing through the liquid crystal shutter 13 of the liquid crystal shutter glasses. Referring to FIG. 1a, when the liquid crystal 12 is driven, an image from the polarizing filter 11a arranged on the front and back surfaces of the liquid crystal 12 is oriented in a single direction. Then, the oriented image is transmitted in a direction parallel with the molecules of the liquid crystal 12 as the liquid crystal 12 is driven. However, the image is intercepted by the polarizing filter 11b arranged on the back surface of the liquid crystal 12 and provided with a polarization direction perpendicular to the transmitted image, thus preventing a user wearing the liquid crystal shutter glasses from viewing the polarized image through the glasses. At this time, the liquid crystal shutter 13 is in a light interception state, in other words, a closed state.

FIG. 1b also shows the propagation of the light passing through the liquid crystal shutter 13 of the liquid crystal shutter glasses. Referring to FIG. 1b, when the liquid crystal 12 is not driven, an image from the polarizing filter 11a arranged on the front surface of the liquid crystal 12 is oriented in a single direction. In other words, as the liquid crystal 12 is not driven, the oriented image is twisted by 90 degrees, prior to passing through the liquid crystal 12. The image passed through the liquid crystal 12 is transmitted through the polarizing filter 11b arranged on the back surface of the liquid crystal 12, thus allowing the user to view the image through the liquid crystal shutter glasses. At this time, the liquid crystal shutter 13 is in a light transmission state, in other words, an open state.

In the above-described manner, the liquid crystal shutter 13, in which the polarizing filters 11a and 11b are respectively arranged on the front and back surfaces of the liquid crystal shutter 13, alternately intercepts or transmits images for left and right eyes by driving the liquid crystal 12 according to the synchronizing signals of the left and right images, thereby allowing the input images to be viewed as stereoscopic images by a user.

In this case, because the left and right liquid crystal shutters 13 are alternately opened and closed according to the synchronizing signals so as to visualize only one image at a time, a flickering phenomenon does not occur when viewing the stereoscopic images. However, if the user views surrounding objects while wearing the liquid crystal shutter glasses, only the liquid crystal shutter 13 is repeatedly closed and opened, while surrounding light as well as images of surrounding objects is continuously transmitted to the glasses, such that awareness of the user with respect to the flickering of the liquid crystal shutter is increased due to the constancy of the surrounding light. Accordingly, the conventional liquid crystal shutter glasses are disadvantageous in that the user wearing the liquid crystal shutter glasses comes to feel fatigue of his or her eyes due to the flickering.

### SUMMARY OF THE INVENTION

Accordingly, the present invention has been made keeping in mind the above problems occurring in the prior art, and an object of the present invention is to provide a stereoscopic image system with a polarization display unit, which in order to enable a user to view a stereoscopic image signal outputted from a display unit for outputting stereoscopic images as a stereoscopic image through polarizing glasses, and to prevent an occurrence of flickering when a user views any surrounding objects not the stereoscopic image with the polarizing glasses, comprises a polarizing filter for polarizing an image outputted from the display unit in a single direction, and a liquid crystal driven according to synchronizing signals of left and right stereoscopic images, wherein a liquid crystal shutter conventionally mounted in glasses and generating the flickering phenomenon is arranged on the display unit to polarize the stereoscopic image in a single direction and to output the left and right stereoscopic images sequentially outputted according to the driving of the liquid crystal to be perpendicular to each other, thus alternately transmitting the outputted left and right stereoscopic images through polarizing glasses having left and right polarizing filters with polarization directions perpendicular to each other and so the user visualizing the left and right stereoscopic images as a single stereoscopic image.

In order to accomplish the above object, the present invention provides a stereoscopic image system with a polarization display unit, comprising a display unit for outputting left and right stereoscopic images for left and right eyes in sequence according to synchronizing signals of stereoscopic image signals; a polarizing filter arranged on the display unit for polarizing the left and right stereoscopic image from the display unit to have a single directional propagation characteristic; a liquid crystal arranged on the polarizing filter to output the left and right stereoscopic images to be perpendicular to each other, and to be driven according to synchronizing signals of the left and right stereoscopic images; and a pair of polarizing glasses comprised of left and right polarizing filters having polarization directions perpendicular to each other such that the left and right stereoscopic images sequentially outputted from the liquid crystal to be perpendicular to each other are alternately transmitted to visualize the left and right stereoscopic images as a single stereoscopic image with an occurrence of a flickering phenomenon when a user views any surrounding object except for the stereoscopic image being prevented.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a view showing the interception of light when a liquid crystal is driven in a conventional liquid crystal shutter;

FIG. 1b is a view showing the transmission of light when a liquid crystal is not driven in the conventional liquid crystal shutter;

FIG. 2 is a view showing the realization of a stereoscopic image through a polarizing filter and a liquid crystal arranged on a projection unit of a projector according to a preferred embodiment of the present invention;

FIG. 3 is block diagram of a projector for realizing a stereoscopic image according to a preferred embodiment of this invention;

FIG. 4a is a diagram showing the state in which a left image signal is transmitted to be parallel with an oriented direction through the liquid crystal and incident on a left polarizing filter in accordance with the present invention; and

FIG. 4b is a diagram showing the state in which a right image signal is perpendicularly transmitted through the liquid crystal and incident on a right polarizing filter in accordance with the present invention.

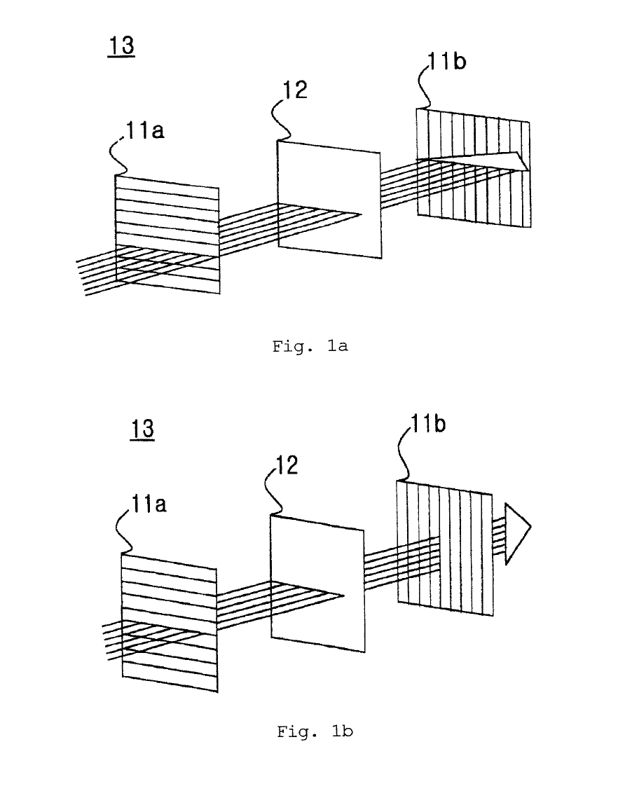

### DESCRIPTION OF THE PREFERRED EMBODIMENTS

Reference now should be made to the drawings, in which the same reference numerals are used throughout the different drawings to designate the same or similar components.

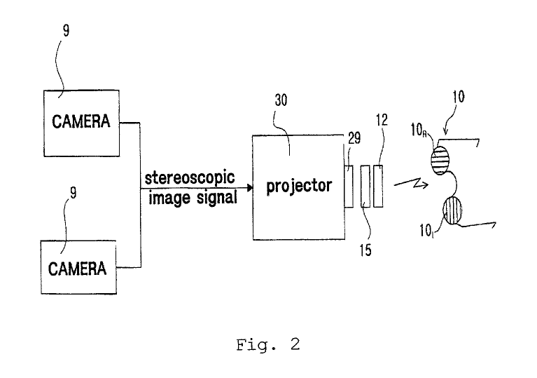

FIG. 2 is a view showing the realization of a stereoscopic image through a polarizing filter and a liquid crystal arranged on a projection unit of a projector according to a preferred embodiment of the present invention. As shown in FIG. 2, a complex stereoscopic image signal of this invention is made by photographing an object with two cameras 9, multiplexing the photographed left and right image signals, and synthesizing the two multiplexed image signals. Such a stereoscopic image signal may be stored in a recording medium such as a memory of a personal computer (PC), a compact disc read only memory (CD-ROM), a digital versatile disc (DVD) and a video tape, and played later. Further, the stereoscopic image signal may be obtained by directly receiving an air media image signal such as a TV image signal in real time, or downloaded through the Internet by a computer to output it.

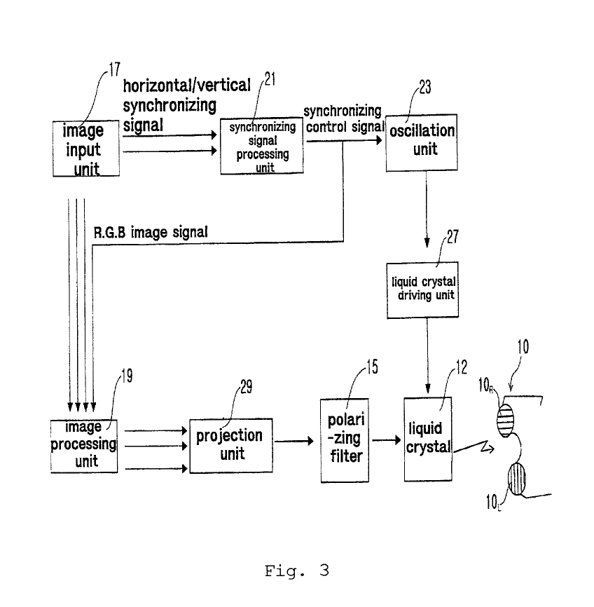

FIG. 3 is block diagram of a projector for realizing stereoscopic images according to a preferred embodiment of the present invention. Referring to FIG. 3, the projector 30 of this invention realizes the stereoscopic image and outputs it through a projection unit 29. In the projector 30, an image input unit 17 is connected to an image processing unit 19 such that the R, G, B image signals from the image input unit 17 are separated into image signals for left and right eyes in response to vertical/horizontal synchronizing signals. The image processing unit 19 is connected to the output terminal of a synchronizing signal processing unit 21 such that the vertical/horizontal synchronizing signals from the image input unit 17 control the image signal separation of the image processing unit 19.

The synchronizing signal processing unit 21 is connected to an oscillation unit 23 for generating an oscillation signal for driving the liquid crystal 12 according to a synchronizing control signal. The oscillation unit 23 is connected to a liquid crystal driving unit 27 for generating a liquid crystal driving signal according to the oscillation signal.

The R, G, B signals are each separated into the image signals for left and right eyes by the image processing unit 19 in response to the synchronizing control signal from the synchronizing signal processing unit 21. The projection unit 29, as shown in FIG. 2, is arranged on an image output side of the projector 30 such that the image signals for left and right eyes are displayed through the projection unit 29 according to the synchronizing control signal. Here, the display means is not limited to the projection unit 29, but may be any display device that enables realization of a stereoscopic image, such as a TV or computer.

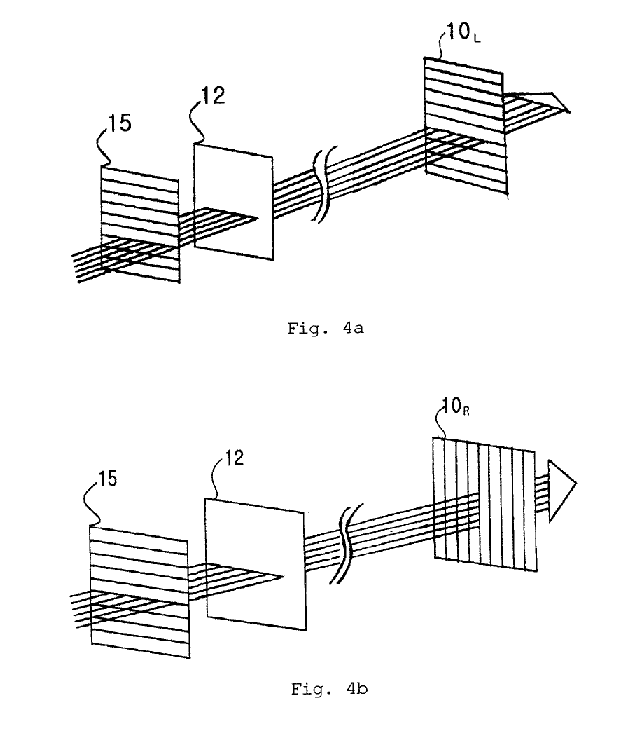

In order to polarize the stereoscopic image outputted from the projection unit 29 in a single direction to display the stereoscopic image, the polarizing filter 15 having a specific polarization direction, such as, a horizontal, a vertical or any possible direction as shown in FIGS. 4a and 4b, is arranged on the projection unit 29. If the direction of the polarizing filter 15 is the same as that of the left polarizing filter 10_{L} of the polarizing glasses 10, as will be described later, so as to selectively transmit the image from the projection unit 29, the direction of the filter 15 must be perpendicular to that of the right polarizing filter 10_{R}. In this case, the left and right polarizing filters 10_{L} and 10_{R} may be arranged in opposite directions.

FIG. 4a is a diagram showing the state of transmitting the left image signal to be parallel with an oriented direction through the liquid crystal 12 and projecting the image signal on the left polarizing filter 10_{L} and FIG. 4b is a diagram showing the state of perpendicularly transmitting the right image signal and projecting the image signal on the right polarizing filter 10_{R}.

Referring to FIGS. 4a and 4b, the liquid crystal 12 is arranged on the polarizing filter 15. The liquid crystal 12 is driven to be synchronized with the image signal oriented in a single direction, and so selectively transmits images therethrough to be parallel and perpendicular to the oriented image according to the synchronizing signals of the left and right images in order to output the left and right image signals to be perpendicular to each other.

The polarizing glasses 10 includes the left and right polarizing filters 10_{L} and 10_{R}, such that user views the left and right images outputted to be perpendicular to each other by the driving of the liquid crystal 12 with his or her left and right eyes, respectively.

Hereinafter, the operation and the effect of the stereoscopic image system of the present invention will be described in detail.

As shown in FIG. 3 as a preferred embodiment of the present invention, the image input unit 17 mounted in the projector 30 is connected to the image processing unit 19. Accordingly, the R, G, B image signals 19 inputted to the image processing unit 19 through the image input unit 17 are each separated into the image signals for left and right eyes according to the synchronizing control signal from the synchronizing signal processing unit 21. The synchronizing signal processing unit 21 receives the vertical/horizontal synchronizing signals and generates the synchronizing control signal according to the vertical/horizontal synchronizing signals from the image input unit 17.

The image processing unit 19 separates the R, G, B image signals into the left and right eyes image signals according to the synchronizing control signal. The separated left and right eyes image signals are outputted as left and right images through the projection unit 29 in response to the synchronizing control signal.

Further, the liquid crystal driving unit 27 is controlled according to the oscillation signal formed by the synchronizing control signal from the synchronizing signal processing unit 21, thus allowing the liquid crystal 12 to be driven in response to the synchronizing signal of the image signal. Thereby, the left and right image signals passing through the liquid crystal 12 are respectively transmitted to be parallel with the oriented direction or perpendicular to the oriented direction (twisted by 90 degrees), thus allowing the left and right image to be outputted perpendicularly to each other.

In more detail, the operation of outputting the left image signal is described. As shown in FIG. 4a, an image is oriented in a single direction by the polarizing filter 15 arranged on the output surface of the projection unit 29 (refer to FIG. 3). The twisted molecule array of the liquid crystal 12 is aligned in parallel with the direction of an electric field when the liquid crystal driving unit 27 drives the liquid crystal 12 according to the synchronizing control signal. Therefore, the image signals passed through the liquid crystal 12 along the molecule array of the liquid crystal 12 have the same polarization direction as the left part of the polarizing glasses 10, such that the image signal is transmitted through the left polarizing filter 10_{L} having the same polarization direction as that of the polarizing filter 15 arranged on the projection unit 29, but the image signal is intercepted by the right polarizing filter 10_{R} having a direction perpendicular to the polarizing filter 15.

In contrast, the operation of outputting the right image signal is described. As shown in FIG. 4b, the image oriented in a single direction by the polarizing filter 15 arranged on the output surface of the projection unit 29 (refer to FIG. 3) is twisted by 90 degrees along the molecule array of the liquid crystal 12 when the liquid crystal 12 is not driven. Accordingly, the image signal is twisted in a direction perpendicular to the oriented direction by the polarizing filter 15 when the liquid crystal 12 is not driven. In this case, the twisted image signal has the same direction as the right polarizing filter 10_{R} having a polarizing direction perpendicular to the left polarizing filter 10_{L}. Therefore, the image signal is transmitted through the right polarizing filter 10_{R} having a direction perpendicular to the polarizing direction of the polarizing filter 15, while the image signal is intercepted by the left polarizing filter 10_{L} having a direction equal to the polarizing direction of the polarizing filter 15.

The polarization directions of the left and right images have the deflection of 90 degrees by the liquid crystal 12 driven according to the synchronizing signals. The left and right images are selectively transmitted through the left and right polarizing filters 10_{L} and 10_{R} of the polarizing glasses, thus allowing the user to view the left image signal with only a left eye and view the right image signal with only a right eye. Thereby, the user may view the stereoscopic image signal with both eyes.

Further, in the polarizing glasses 10 of this invention, the liquid crystal 12 is arranged not on the glasses, but directly on the projection unit 29. Accordingly, the user receives the image only from the stereoscopic image projection unit 29 as a stereoscopic image. Moreover, when the user views the surrounding objects except for a stereoscopic image, flickering occurring in the conventional liquid crystal shutter glasses can be perfectly eliminated.

As described above, the present invention provides a stereoscopic image system with polarizing glasses, which has advantages that a user can visualize stereoscopic image signals outputted from a display unit as a stereoscopic image, and a flickering phenomenon when the user views surrounding objects except for a stereoscopic image is minimized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A stereoscopic image system with a polarization display unit, comprising:
a display unit for outputting left and right stereoscopic images for left and right eyes in sequence according to synchronizing signals of stereoscopic image signals;
a polarizing filter arranged on the display unit for polarizing the left and right stereoscopic image from the display unit to have a single directional propagation characteristic;
a liquid crystal arranged on the polarizing filter to output the left and right stereoscopic images to be perpendicular to each other, and to be driven according to synchronizing signals of the left and right stereoscopic images; and
a pair of polarizing glasses comprised of left and right polarizing filters having polarization directions perpendicular to each other such that the left and right stereoscopic images sequentially outputted from the liquid crystal to be perpendicular to each other are alternately transmitted to visualize the left and right stereoscopic images as a single stereoscopic image with an occurrence of a flickering phenomenon when a user views any surrounding object except for the stereoscopic image being prevented.
